(19) United States
(12) Patent Application Publication
(10) Pub. No.: US 2014/0372132 A1
(43) Pub. Date: Dec. 18, 2014

(54) ELECTRONIC DEVICE AND SYSTEM FOR RECEIVING DETAILS OF SEQUENCE NUMBERS IN QUEUES AS THEY OCCUR IN ONE OR MORE HEALTH CENTRES, TRANSMITTED BY RADIO DATA SYSTEM

(71) Applicant: DAVID TARDIO, Laval, CA (US)

(72) Inventor: DAVID TARDIO, Laval, CA (US)

(73) Assignee: David Bensoussan, Montreal, CA (US)

(21) Appl. No.: 13/916,624

(22) Filed: Jun. 13, 2013

(51) Int. Cl. G06Q 50/22

(52) U.S. Cl. CPC G06Q 50/22
USPC 705/2

(57) ABSTRACT

This invention relates to a method and a portable electronic device that uses a (RDS) Radio Data System or (RDBS) Radio Broadcast Data System to show the sequence number of a waiting line in a health-care center, e.g. a hospital. Users use a portable RDS reception electronic device, which includes an RDS information receiver, to get information on the sequence number of the patient being treated at the moment and may be alerted that their turn is or is about to be imminent. In this way, users can better utilize their time and not needlessly crowd waiting rooms. The invention also allows the reception of customized information sent to a specific sequence number or to a specific portable RDS reception electronic device from one or many health centers.

### FIELD OF THE INVENTION

The present invention deals with systems and/or electronic devices using radio transmission of data.

### BACKGROUND OF THE INVENTION

(1) The present invention aims to provide the user with a portable electronic device to remotely verify the number sequence of a queue corresponding to the order in which the users of a given service are being be treated. The device includes an RDS receiver in which it is possible to check the number of the patient being treated to prevent a prolonged wait for the user and to decongest the service areas in which users are waiting. This device, which is autonomous, portable and available for any user, enables shorter queues for users of a particular service allocated by an Allocation Centre of the Health Service. More specifically, the present invention targets:

(2) An electronic handset device enables a user to know the sequence number of the user being treated in a service allocation area
means of information communication on appropriate RDS frequency;
means of reading information on a RDS terminal.
means of selecting a specific RDS channel relative to a Health Dispensing Centre
means of communicating to a specific user customized information to a specific user sequence number . . .
means of communicating customized information to a specific portable electronic RDS.

(3) The congestion in some waiting rooms has become problematic, especially in some hospitals. There are many busy Allocation Service Centres in which users are invited to take a number and wait their turn to be served: waiting rooms in medical clinics, in the polyclinics, hospitals, etc.

The present invention allows a user to verify the number of users waiting to be treated or even choose the institution that would deal with him more rapidly. Once he has taken a number, or a number was assigned in a waiting room, the portable electronic RDS device can compare this number to that of the person being treated to estimate the free time available to him. The portable electronic device can alert the user that his turn is approaching, e.g., there are 5 more patients before him or that it is now his turn. This information can be in the form of acoustic vibrations, tones or audio messages, or even be displayed on the RDS portable electronic device. Being made aware of waiting times by means of a telephone greatly limits the patient's mobility. Patients who are made aware of waiting times by means of a standard cell phone, a smart phone (without RDS with FM frequency modulation) or an application designed for a smart phone, must accept service charges and communication costs at regular intervals to determine the progression of the sequence number being treated by the health centre. In addition, cell phones emit electromagnetic waves that spread in all directions, and can cause interference which could disrupt the reading or the operation of some medical equipment. Even if cases are relatively rare, as a precaution, hospitals generally prohibit or limit their use. By contrast, an inexpensive electronic portable RDS device might be useful as it would avoid repetitive or expensive charges and does not cause harmful interference, which could disrupt the reading or the operation of some medical equipment. The present invention allows the use of the geographical coverage of FM radio stations in order to receive the desired information at appreciable distances from the health center. The information received is virtually in real time and, in addition, information accompanying the sequence number can include the waiting area, the average time between patients or even an estimation of the total waiting time.

The patent application CA 2204101 entitled Boitier portatif pour informer les usagers d'un réseau d'autobus sur les temps d'attente aux arrêts de ce réseau proposes a portable and interactive device that receives data pertaining to the evaluation of the time of arrival of the next bus. U.S. Pat. No. 5,471,662 of Shiota entitled Radio data system receiver allows choosing particular information of the Identification code PI (Program Identification Code) within the RDS channels and selecting the one with the best reception. U.S. Pat. No. 4, 881,273 of Koyama and al entitled RDS System radio, proposes to cease sweeping the frequency band as soon as a good quality PI information has been identified and that the received signal reception level is satisfactory; U.S. Pat. No. 5,572,194 of Shiota Broadcast receiver and signal reproduction apparatus controlled using RDS data proposes to decode the RDS data and generate a remote control signal; U.S. Pat. No. 5,898,910 of Miyake entitled RBDS Receiver provided with a data base having broadcasting station related information proposes to update an RDS data base attached to a particular transmitter. U.S. Pat. No. 7,412,205 de Jarvi and al entitled Two channel Communication system using RDS Datastream broadcasting describes a bidirectional system the RDS information of which interfaces an interactive mobile platform corresponding to a service center. U.S. Pat. No. 7,340,249 entitled Use of Radio data service information to automatically access a service provider describes a wireless device that includes an RDS decoder the data of which is used to initiate a communication with a service center with a human agent.

Patent CA 2204101 is based on the transmission of waiting time based on a fixed schedule and differs from the present invention which is based on real time transmission of non-scheduled sequence numbers attribution. U.S. Pat. Nos. 5,471,662 and 4, 881,273 deal with technical aspects of RDS. U.S. Pat. No. 5,572,194 uses RDS signals for remote control activation. U.S. Pat. No. 5,898,910 deals with radio broadcast related data and not with data which is independent of a given broadcast. U.S. Pat. No. 7,412,205 patent refers to an interactive RDS link, which is not the object of the actual invention. U.S. Pat. No. 7,340,249 refers to an RDS signal conveyed within a system that involves one person (a human agent) which is not the aim of the present invention.

The RDS data is transmitted within a frame (the RDS frame) according to the UECP (Universal Encoder Communication Protocol) protocol. The digital data is modulated on a subcarrier of 57 kHz, which is three times the pilot frequency that accompanies FM radio transmissions and includes, among other information, types of specified codes, such as:

PS: Program Service: This is an eight-character static display that represents the call letters or station identity name.

PI: Program Identification: This is the unique code that identifies the station.

AF: Alternative Frequency: This allows a receiver to re-tune to a different frequency providing the same station when the first signal becomes too weak.

PTY: Program Type: This coding allows users to find similar programming by genre.

PTYN: Program Type Name: Allows more flexibility for the broadcaster who desires to be set out from his peers.

EON: Enhanced Other Networks: Allows the receiver to monitor other networks or stations for traffic programs and tune to that station.

ODA: Open Data Applications: data information reserved for private and public applications. ODA also allows ciphering of the data. The ODA field is identified by a special ID number. The data issued by the health center is encoded (e.g. alphanumeric code), coded (with detection and correction coding methods) and ciphered within a software patch (CF. Scott Wright, The broadcaster's guide to RDS, Focal printing, 2006)

Hereinafter, we will use the following definitions:

Health Centre: Health Centre serving patients according to a sequential order in the same way as a hospital, a clinic, a polyclinic, a Local Community Service Centre, a medical clinic, a health institution, a health care facility. Moreover, this Centre could include any Service Centre seeing patients according to a sequential number system.

Information or data: information provided in RDS transmitter by the Health Centre. The information can be alphanumeric information and also includes the actual number given to the most recent user so that it would become possible to estimate the length of the queue within each health center. Information can also include dedicated data specific to the sequence number or customized (personalized) data specific to the RDS receiver (e.g. identification by serial number).

Dedicated information: information available to the general public issued by a Health Centre.

Customized information: information intended for a specific receiver or patient.

RDS encoder or RDS transmitter: An encoder which places the input data and places it within specific data fields such as an ODA field before it is modulated and associated by mixing to an FM transmitter.

Open RDS system: RDS communication system which covers a large geographical zone such as the zone coverage of a commercial FM radio, as opposed to a closed RDS system in which the coverage is limited and local, and is defined by a transmitter close to the health center or within the health center.

Interface: an interface is a wired, wireless or Internet means by which it is possible to transmit information issued by a health center to the RDS encoder. As an example, a push button can activate a counter within a health center which indicates the sequence number of a user. This information is sent to an RDS encoder associated to an FM transmitter. For example, the RDS encoder can identify an IP address and place the information in data specific fields such as the ODA field.

Intelligent Terminal: computer, electronic pad or Smartphone allowing reception and processing of information.

Hereinafter, RDS electronic portable reception device is also named RDS portable electronic receptor device

Means of display: means that allow the patient to read the transmitted information. These means can be visual, acoustic, audiovisual and include alphanumeric or iconic display techniques.

Sequence Number A: sequence number currently being treated in the Health Centre. This number is part of the data transmitted by the Health Centre. It may be an ordinal number or an alphanumeric sequential code.

Sequence Number B: sequence number of the patient in possession of an electronic device equipped with portable RDS; this number is assigned by the Health Centre. It may be an ordinal number or an alphanumeric sequential code.

Sequence Number C: indicator of the difference between B and A.

USB key: Standard USB key or any other similar device with its particular connector, including the keys equipped with wireless communication such as Bluetooth.

### BRIEF DESCRIPTION OF THE DRAWINGS

4) Relative to the drawings illustrating the invention:

FIG. 1 represents the synoptic diagram of a Health Centre communicating information relative to a queue sequence number to a Radio Data System (RDS) transmitter, the signal being detected by an electronic portable RDS reception device.

FIG. 2 represents the synoptic diagram of a portable electronic RDS reception device.

FIG. 3 represents the synoptic diagram of an example of the execution of the internal structure of an RDS electronic receptor device.

FIG. 4 represents the synoptic diagram of a network of Health Centres providing data to a set of RDS transmitters and a set of portable electronic RDS receptor devices receiving the said data.

FIG. 5 represents an algorithm of the operation enabling identification of a specific Health Centre service transmitting RDS data.

FIG. 6 represents an algorithm for updating the data transmitted by the Health Centre.

FIG. 7 represents an algorithm of an operation permitting knowledge of the number of patients that must be seen before the patient whose queue number is known and enables triggering an acoustic or audiovisual alert when the sequence number transmitted to the RDS data is close to the patient's sequence number.

FIG. 8 represents the synoptic diagram of a portable electronic RDS reception device communicating with a Health center and with an intelligent terminal.

### DESCRIPTION OF RELATIVE EMBODIMENTS

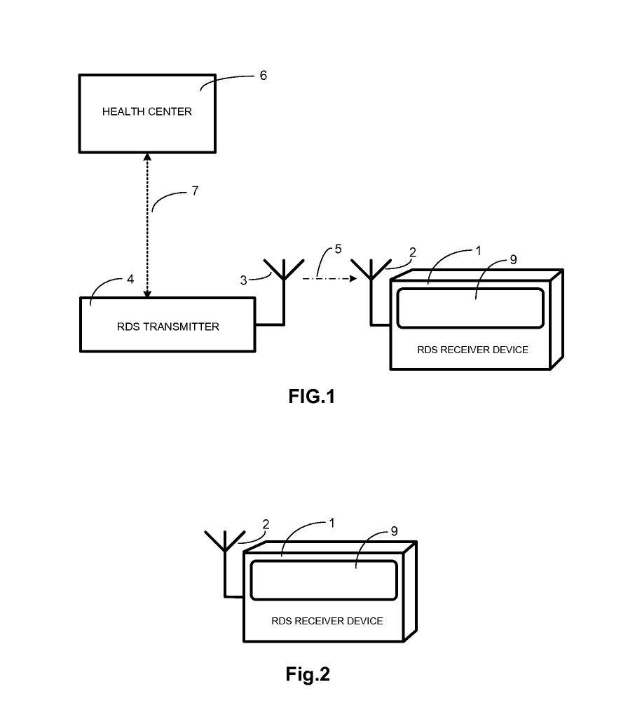

5) FIG. 1 shows a health center (6) linked to a Radio Data System (RDS) communications: information, such as digital data transmitted by the health center (6) is sent to the electronic portable RDS receiver device (1) through a communications link (7) which may be wired or wireless. This information goes through a RDS transmitter (4) before being transmitted through the broadcasting antenna (3). This transmitter generally broadcasts in the FM band and the data is modulated on RDS subcarriers holding the digital RDS data. The transmission from the antenna (3) propagates through the atmosphere (5) to be received through the antenna (2) of an electronic portable RDS receiver device (1) and then displayed through the information display module (9).

FIG. 2 shows an electronic portable RDS receiver device (1) and its receiving antenna (2), as well as an information display module (9).

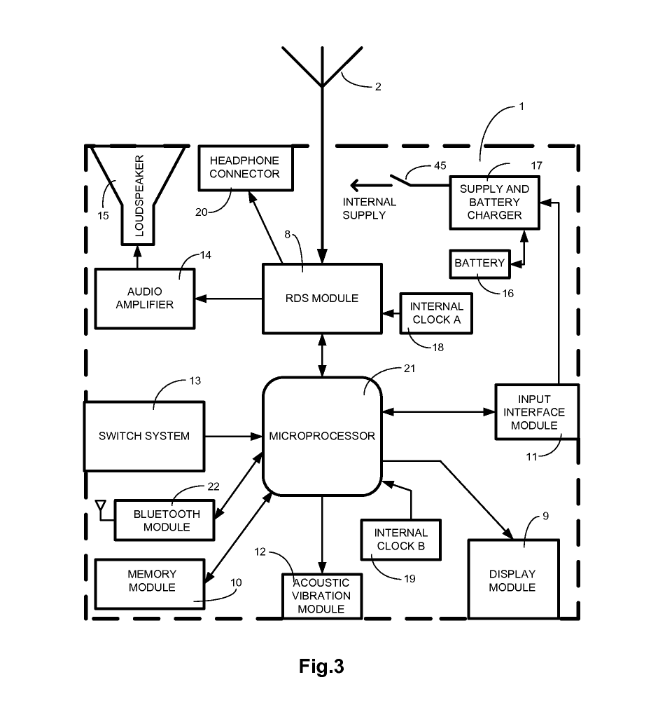

FIG. 3 shows an example of the internal structure of an electronic portable RDS receiver device (1). The antenna (2) may be internal or external to the electronic portable RDS receiver device (1). The antenna (2) receives the FM signal with the RDS data. The RDS data is decoded through a RDS module (8), which operates through an internal clock A (18), and is processed within a microprocessor (21), which operates through an internal clock B (19). A switch system (13) offers the possibility of choosing the specific data that is processed within the microprocessor (21), which displays the selected information through the display module (9) and stores it in memory in the memory module (10) if necessary. The memory module (10) contains permanent sub-memory and temporary sub-memory accessible to the microprocessor (21). This memory module (10) may also contain the serial number of the electronic portable RDS receiver device (1). The microprocessor (21) may also be addressed through an input interface module (11) which transfers the data to the microprocessor (21). This input interface module (11) may be a USB communications connection that may also serve to power the electronic portable RDS receiver device (1) or to charge the battery (16) through the power adapter and battery charger (17) of the electronic portable RDS receiver device (1). It can also be a Bluetooth interface or an Ethernet interface in order to transmit information by data transmission means or by Internet. Optionally, the battery (16) may be autonomous and independent of power or of the battery charger (17). The output signal of the microprocessor (21) may be routed to an audio amplifier (14) connected to a loudspeaker (15) or even to a headphone connector (20), to provide the option of having external headphones or an acoustic vibration module (12) This RDS data may be displayed in the display module (9). The display module (9) may be a touchscreen used to send commands to the microprocessor (21). Main power sources include a power module and battery charger (17) and a battery (16). The electronic portable RDS receiver device (1) may be activated or deactivated through the main switch (45). Optionally, a Bluetooth interface (22) may be used for transmission of supplementary information. Needless to say, the electronic portable RDS receiver device (1) may include some of the functions described in FIG. 3.

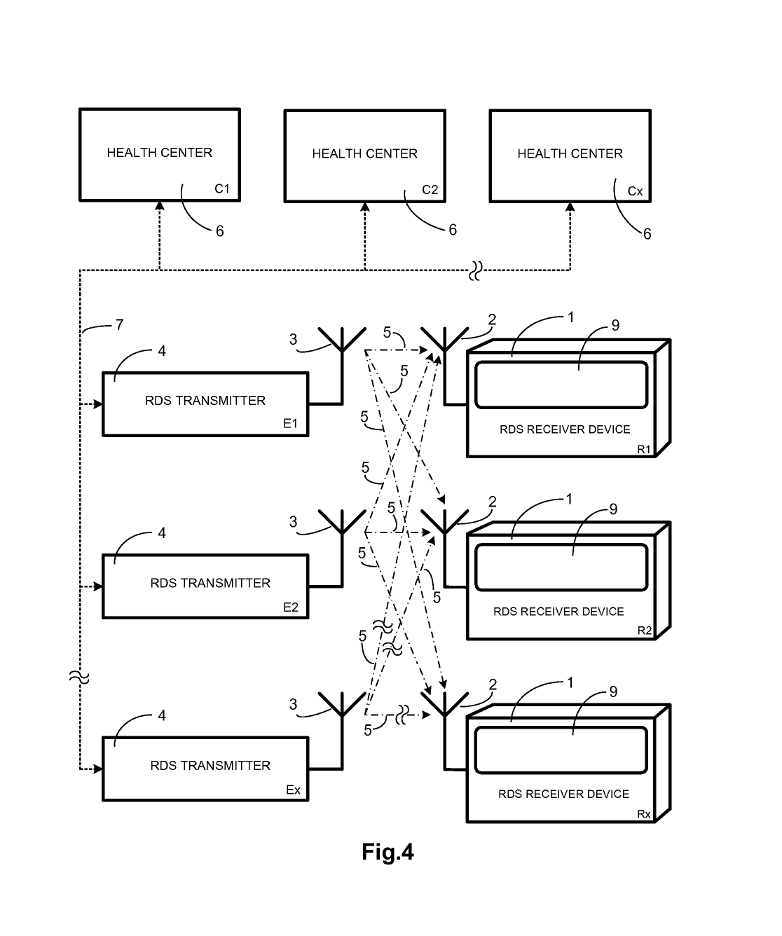

FIG. 4 shows several health centers (6) (C1, C2 . . . Cx), which communicate their data through the communications link (7), which may be wired or wireless, to the RDS transmitters (4) (E1, E2 . . . Ex) equipped with their respective antenna (3). The antenna (3) may be located at a distance from the RDS transmitter. The radio waves of the FM band (5) containing the digital RDS data transmitted by these antennas (3) propagate through the atmosphere (5) to be received in the receiver antennas (2) of the electronic portable RDS receiver devices (1) (R1, R2 . . . Rx).

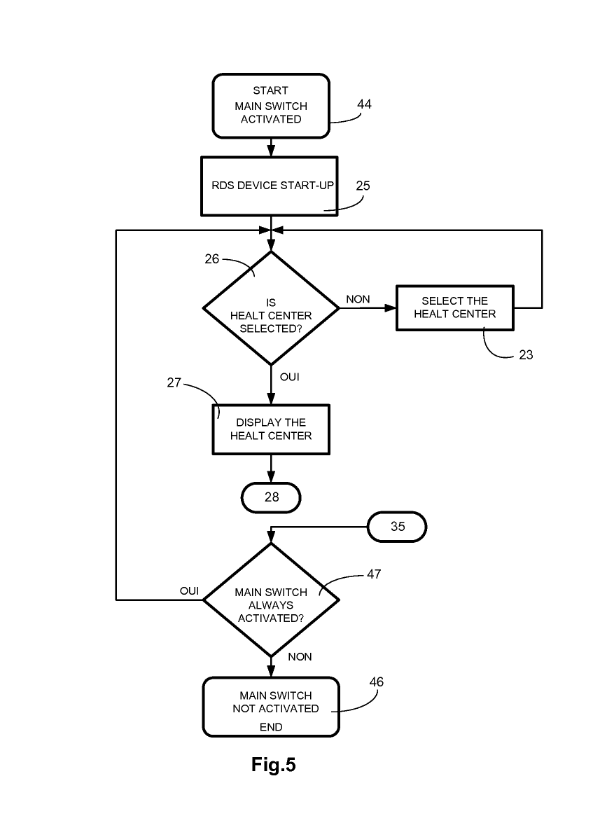

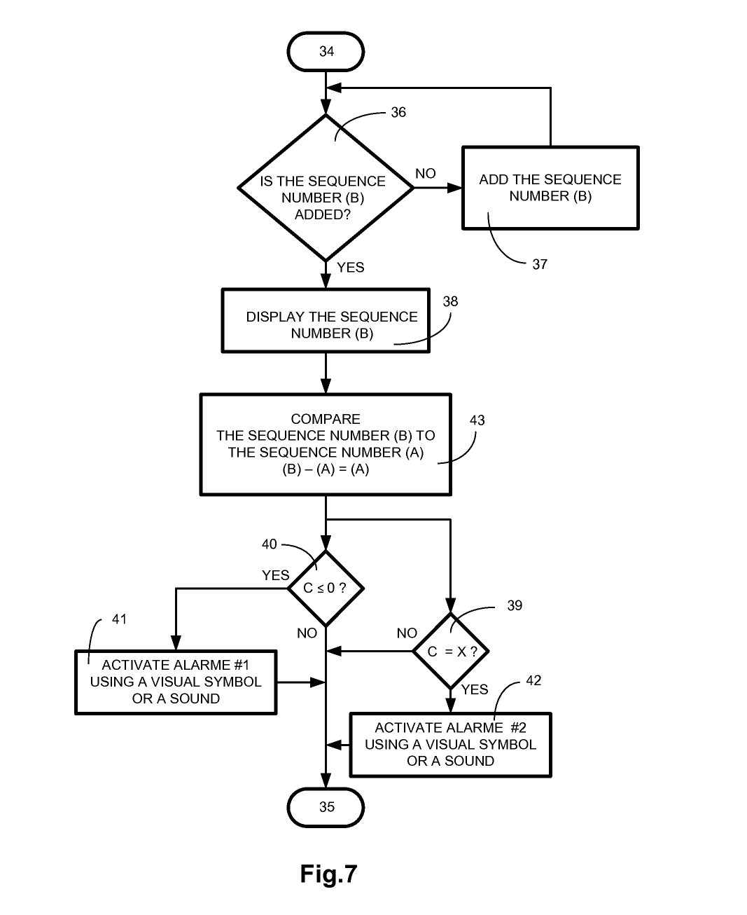

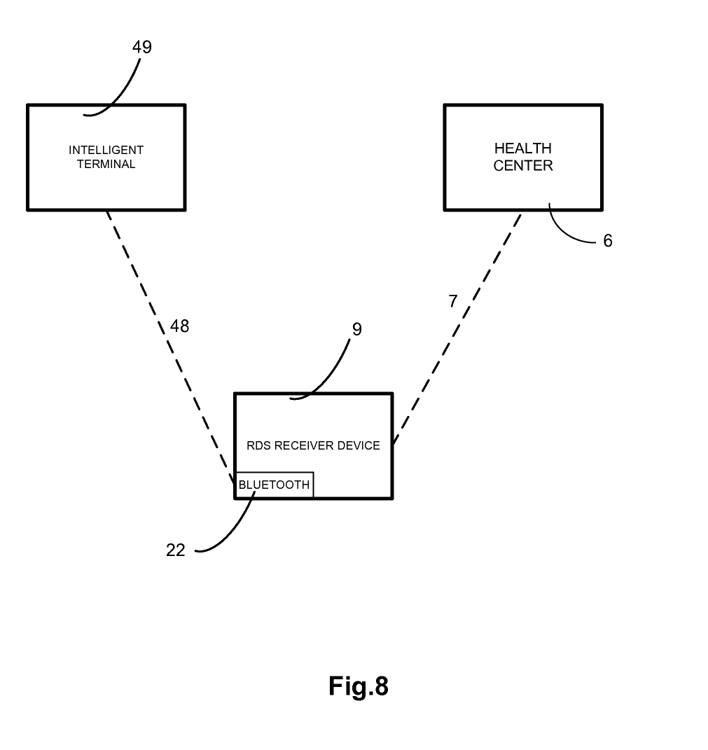

FIG. 5 shows the activation of the electronic portable RDS receiver device (1), consisting in an operational algorithm that allows for the identification of a health center transmitting RDS data. Following activation (44) through the use of the switch (45) of the electronic portable RDS receiver device (1) comes the start-up stage (25) of the electronic portable RDS receiver device (1), then a selection (26) of a specific health center or even of a particular service within that health center. Optionally, this choice may incorporate information about geographical areas that converge towards the sites and the places for health services. Identification of the appropriate health center is selected and then displayed (27). If the health center is not the correct one, the algorithm continues its search (23). Afterwards, the algorithm, which is in the final stage, arrives at stage 28. In case the turn of the sequence number for the user arrives (35) (FIG. 7), it is necessary to verify if the electronic portable RDS receiver device (1) is still active. In case of a deactivation of the electronic portable RDS receiver device (1) (47) through the main switch (45) (FIG. 3), the operation of the algorithm comes to an end (46). If the main switch (45) is still on (47), the algorithm arrives at stage 26.

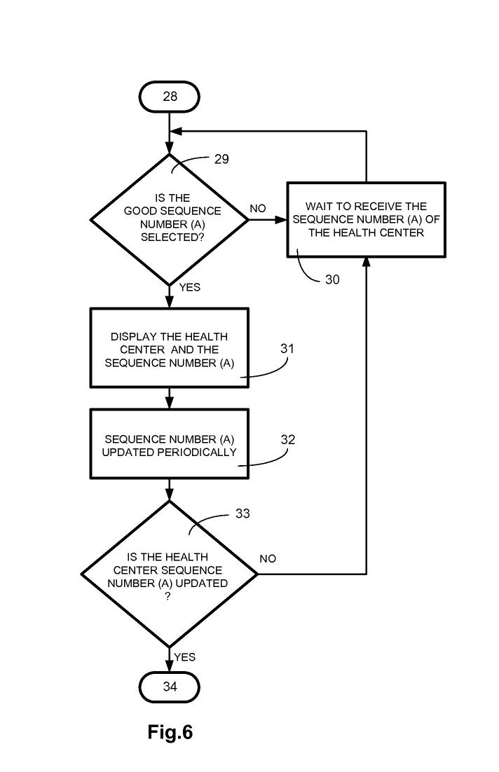

FIG. 6 shows an operational algorithm that allows for verification of the periodical update of RDS data. The algorithm, at stage 28, verifies whether the data (a) of the selected health center is correct (29) and, this way, the user may be aware that the health center transmits the displayed information in RDS (31). In case the information about the sequence number (A) is updated (33), the display module (9) is also updated. The periodical update of the sequence number (A) (32) is established and the algorithm arrives at stage 34. Otherwise, the algorithm arrives at stage 30 in order to wait to receive the next sequence number (A).

FIG. 7 shows an algorithm which can trigger an acoustic or audiovisual alert when the sequence number of the health center (A) sent in the RDS data is close to or identical to the sequence number for the user (B). The algorithm begins at stage 34. The user enters his or her sequence number (B) (36) customized through the switch system (13) or through the display module (9) which may have a touchscreen, which is then displayed (B) (28). If not, it continues to the stage of adding the sequence number (B) (37). The sequence number (B) is compared (43) to the handled sequence number (A). The difference (C) is obtained (43), calculated (40) in the following fashion: sequence numbers A and B are compared and a characteristic signal is sent as soon as A becomes close to B. If the value of C is equal to X (39), for example X=5, a #2 alarm is triggered to alert the user that his or her turn is close and the algorithm goes to stage 35. When C is greater or equal to zero (C≦0) (4), alarm #1 (41) is triggered to alert the user that his or her turn has come up or is over, then the algorithm goes to stage 35. A characteristic signal may be sent to output transducers, such as a vibrator, audio outputs, or displays on a screen. Based on the average lengths of the last periods that separate the sequence numbers processed, the user may obtain an estimate of the waiting time and thus better manage his or her time. At stage 35 (FIG. 5), the electronic portable RDS receiver device (1) verifies, at stage 47,whether the main switch (45) is on. In this case, the algorithm goes back to stage 26. Otherwise, the electronic portable RDS receiver device (1) is deactivated and arrives at the final stage.

Dedicated information may accompany the transmission of the sequence number currently being handled at the health center. It is also possible for a user number to be associated to a specific electronic portable RDS receiver device that is identified by a serial number at the service center, for instance, at the moment of issuing a sequence number. Identification of a particular user may be done at a health center and, thus, the information sent by the health center database may be targeted towards a specific electronic portable RDS receiver device, coded or encrypted as desired, using coding software, encryption software or coding/encryption software. Recall that ODA allows the ciphering of the data. There is also a way of prioritizing certain sequence numbers above others. This identification may include reading the serial number of the RDS radio or a personal identification number such as a social security number, through electronic means, in such a way as to be able to transmit personalized information. These electronic means may also be integrated into the electronic portable RDS receiver device, through the wired links, or even through Bluetooth connections, where transmission is deactivated as soon as identification takes place. It then becomes possible to reach a specific user, thus transmitting dedicated information by the health center to a particular sequence number or to a particular RDS device. In this fashion, as an example, the user may receive special instructions related to specific tests: dietary conditions, necessary identification, expected stay, or any other relevant instructions, including personalized information. For example, this customized information (text, images, audio recording or video recording) may be displayed if the electronic receiver's serial number found in the memory of the electronic portable RDS receiver device is identical to the one that the health center wishes to contact.

It is also possible to display a set of dedicated information transmitted by a health center from a database as long as the electronic portable RDS receiver device is found close to a terminal with a Bluetooth connection or a connecting cable that connects it to the electronic portable RDS receiver device. In this fashion, for example, a user in a hospital may find dedicated information or information related to the hallways and elevators he or she needs to take.

The electronic portable RDS receiver device thus serves as a key to access the database of the health center. For example, Bluetooth communications may establish a connection between the electronic portable RDS receiver device and an intelligent terminal so that the relevant databases of the health center are immediately accessible from said intelligent terminal. In this way, the RDS device can incorporate alerting means (alphanumeric display, acoustic vibrations or audio signals) and can be used to access a database (with the possibility of identification with a personalized identification number) within an intelligent terminal. As an example, the Bluetooth module 22 can be used to transmit a sequence number to the microprocessor 21. This Bluetooth module 22 can also be used to communicate to an intelligent terminal. Once the communication is established, this access key connects the user to a data base of the health center which originated the sequence number. This data base can also be an independent one or be part of an Internet site or a particular file within an Internet site. In this way, it will be possible to use more elaborate audio-visual means of said intelligent terminal or even to access by telephone or by Internet a particular data base. In this way, it will be possible to show a set of data transmitted by the health center once the RDS receiver is in the vicinity of a terminal that can be accessed through a wireless connection, Bluetooth, a USB connection or a cable linking the USB key to the terminal.

The sequence number detection algorithms transmitted by the RDS radio may be incorporated into a dedicated app in an intelligent device, such as an iPhone, an iPad, an Internet connection, etc. They may be integrated into a dedicated electronic portable RDS receiver device that may be integrated into an interactive device, such as a multimedia device (mp3 player or similar) or any intelligent terminal that allows for the reception of information and its use.

The receiver device described in this invention does not only apply to health services, but to any service center that operates by giving users a certain sequence number. The unused band in the FM spectrum could also be used for dedicated RDS transmissions.

The distribution of information within a network of FM transmitters could be centralized in order to optimize the distribution of sequence numbers within different health centers (to distribute the load and avoid congestion) and give a better service in emergency situations so that users can be redirected to different health centers. In the case of many health centers, the transmitted informations can be centralized and processed in order to alert a user that another health center has a smaller number of users waiting in line. For example, this alert can take the form of a particular alphanumeric sign such as a pound. The links 7 of the health centers 6 can be regrouped in a separate processing unit such as a computer or simply integrated within a software patch within the RDS encoder 4. This centralized management contributes to even the load (in terms of the number of users waiting in line) of different health centers.

Since many partial modifications may be made on the invention described here and several apparently different filings may be added along with the filing for this patent, it is understood that any contents found in the provided specifications in the patent described here must be interpreted as being simply illustrative and not limiting. In this fashion, for instance, the electronic portable RDS receiver device may also be used as an alpha-MLS; it may be portable but also fixed; the database of the health center it communicates with may be a multimedia database; and so on.

1. A portable electronic device for indicating a sequence number A of a queue of an health center, said sequence number A representing a user to be treated or being treated according to a predetermined order, said device comprising:
an antenna for receiving a data radio system signal, hereafter RDS signal, said RDS signal including the sequence number A;
an RDS module for decoding the RDS signal received by the antenna into a digital signal;
a processor linked to a memory module for receiving said digital signal from the RDS module for extracting the sequence number A within the digital signal;
a display linked to the processor, for displaying the sequence number A; and
a main battery for powering the RDS module, the processor and the display.

2. The device according to claim 1, wherein the processor is configured to decode specific content within an Open Data Applications message, hereafter ODA message, the sequence number A being included in the ODA message.

3. The device according to claim 1, wherein the memory module comprises :
a second sequence number B, representing an order number within said queue of a user using the portable device, the sequence number A being a first sequence number;
instructions executable by the processor for comparing the first and second sequence numbers A, B and for determining a difference C between the second and first numbers B, A;
the display means allowing to display said difference C.

4. The device according to claim 1, wherein the memory module comprises executable instructions to decode additional information included in the RDS signal sent by the health center.

5. The device according to claim 1, wherein the RDS module, the process or and memory module are configured to detect other sequence numbers embedded in RDS signals sent from several other health centers, each sequence number being associated with a given one of the several other health centers.

6. The device according to claim 1, wherein the RDS module is configured to detect the RDS signal when mixed with a commercial FM radio signal.

7. The device according to claim 3, wherein the processor and memory modules are configured to decode additional dedicated information within the RDS signal, said information being associated to either one of the first and second sequence numbers A, B.

8. The device according to claim 1, wherein the processor and memory modules are configured to decode additional dedicated information within the RDS signal, said information being associated to the device.

9. The device according to claim 1, in combination with an intelligent terminal , the device comprising an interface module accessible via Bluetooth™, USB, or Ethernet, for accessing additional information when the device is connected to the intelligent terminal.

10. A system for communication sequence numbers of a queue, the system comprising:
at least one device as defined in claim 1;
at least one RDS interface linked to the health center, the RDS interface including an input port for receiving the sequence number A for a sequence number generating system, means to generate an RDS frame including the sequence number A, and an output port for transmitting the RDS frame to an RDS transmitter.

11. The system according to claim 10, comprising the RDS transmitter, the RDS transmitter being part of an open RDS system.

12. The system according to claim 11, wherein the RDS transmitter transmits the RDS signal via a commercial FM radio antenna.

13. The system according to claim 10, comprising an interface for communicating with an external database.

14. The system according to claim 10, wherein the portable RDS devices comprise means to uniquely identify the receiver.

15. The system according to claim 10, comprising a centralized system, for managing sequence numbers generated by several additional health centers.

16. A method for indicating a sequence number A of a queue of an health center to a user of a portable device, the sequence number (A) representing another user to be treated or being treated, said device comprising the following steps:
a) receiving a data radio system signal, hereafter RDS signal, via an antenna, the RDS signal including the sequence number (A);
b) decoding digital data comprised within the RDS signal received at step a); and
c) displaying to a user of the portable device the sequence number A.

17. The method according to claim 16, further comprising the following steps:
d) generating an RDS frame including the sequence number (A); and
e) transmitting the RDS frame to an RDS transmitter.

18. The method according to claim 16, comprising a step of transmitting via a public FM radio antenna an RDS signal including the RDS frame information, the RDS signal including information relating identifying at least one specific health center.

19. A method according to claim 16, comprising a step of detecting an Open Data Applications message, hereafter ODA message, the sequence number A being included in the ODA message.

20. A method according to claim 16, comprising a step of accessing a data base on an intelligent terminal.

21. A method according to claim 18, wherein the step of transmitting the RDS signal is made via an open RDS system.
